(19) United States
(12) Patent Application Publication
(10) Pub. No.: US 2007/0080602 A1
(43) Pub. Date: Apr. 12, 2007

(54) Brush apparatus for rotary electric machine

(75) Inventor: Hiroki Yoshimura, Oobu-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/527,597

(22) Filed: Sep. 27, 2006

(30) Foreign Application Priority Data
Oct. 7, 2005 (JP) 2005-294468
Jun. 27, 2006 (JP) 2006-176714

(51) Int. Cl. H01R 39/38

(52) U.S. Cl. 310/239; 310/71

(57) ABSTRACT

A brush apparatus for a rotary electric machine has a brush body contacting with a slip ring of a rotor, a spring pressing the brush body on the slip ring, a brush wire connected with the brush body, and a brush terminal having a connecting hole. A ratio of an inner diameter of the hole to an outer diameter of the wire is set to be equal to or higher than 1.3 and to be lower than 1.5. The brush wire is inserted into the hole of the brush terminal, and the brush wire and the terminal are soldered together so as to electrically connect a field winding of the rotor with a rectifier through the brush apparatus.

### CROSS-REFERENCE TO RELATED APPLICATION

This application is based upon and claims the benefit of priority of the prior Japanese Patent Application 2005-294468 filed on Oct. 7, 2005, and the prior Japanese Patent Application 2006-176714 filed on Jun. 27, 2006 so that the contents of which are incorporated herein by reference.

### BACKGROUND OF THE INVENTION

1. Field of the Invention

The present invention generally relates to a brush apparatus which slides on a slip ring of a rotor during rotation of the rotor to supply an exciting current to a field winding of the rotor in a rotary electric machine such as an alternator used for a vehicle.

2. Description of Related Art

A brush apparatus is mounted in an alternator for a vehicle and slides on a slip ring of a rotor during rotation of the rotor to supply an exciting current to a field winding of the rotor. The alternator generates a three-phase alternating current in response to the exciting current.

For each of three phases, the brush apparatus has a terminal receiving an exciting current from a rectifier, a brush body, a brush copper wire connecting the terminal with the body, and a spring pressing the brush body on the slip ring. The brush body and spring are held in a brush holder made of resin. One end portion of the wire is fixed to the brush body due to calking, and the other end portion of the wire is mechanically and electrically connected with the terminal. The wire is folded back in the brush holder so as to be shifted with the brush body. The current is supplied to the rotor through the wire and the brush body during rotation of the rotor. In this case, a portion of the brush body contacting with the slip ring of the rotor is gradually worn away. However, because the spring always presses the brush body on the slip ring, the brush body can continuously contact with the slip ring regardless of wear of the brush body.

To electrically and mechanically connect the wire with the terminal, the wire is inserted into a hole of the terminal and is soldered with the terminal. This connection is, for example, disclosed in Published Japanese Patent Second Publication No. H07-32571 (1995). In a conventional brush apparatus, to facilitate the insertion of a wire into a hole of a terminal, an inner diameter of the hole is set to be 1.5 or more times larger than an outer diameter of the wire.

However, because the inner diameter of the hole is 1.5 or more times larger than the outer diameter of the wire, a clearance or opening between the wire and the terminal in the hole becomes too large to adequately solder the wire and terminal together. More specifically, as the clearance is increased, a larger volume of solder is required to tightly connect the wire with the terminal, and a surface area of the wire covered with the solder is widened. The wire is made by knitting a large number of thin copper wires into a single thick wire, so that the wire has an adequate level of elasticity. Therefore, as the clearance is increased, a larger volume of solder penetrates into the wire. When a large volume of solder penetrates into the wire, the penetrating solder sometimes reaches a bending portion of the wire. The solder reaching the bending portion of the wire lowers elasticity of the wire. In this case, when a portion of the brush body contacting with the slip ring is worn away, the wire loosing elasticity thereof causes the brush body not to be shifted toward the slip ring. As a result, a pressing force of the brush body onto the slip ring is lowered, and there is high probability that the brush apparatus undesirably fails in contacting sufficiently with the slip ring at an early time. Therefore, failure in power generation occurs in the alternator. In contrast, when a volume of solder used to connect the wire with the terminal is reduced to lower a volume of solder penetrating into the wire, there is a high probability that the solder connecting the wire with the terminal could easily come off so as to electrically disconnect the wire from the terminal. In this case, contact failure also occurs in the brush apparatus at an early time so as to cause power generation failure in the alternator.

### SUMMARY OF THE INVENTION

An object of the present invention is to provide, with due consideration to the drawbacks of the conventional brush apparatus, a brush apparatus wherein contact of a brush body with a rotor is reliably maintained, regardless of wear or abrasion of the brush body, so as to prevent failure in power generation or rotational force generation in a rotary electric machine.

According to an aspect of this invention, the object is achieved by the provision of a brush apparatus for a rotary electric machine, comprising a brush body contacting with a slip ring of a rotor, a pressing member pressing the brush body on the slip ring, a brush wire connected with the brush body, and a brush terminal having a connecting hole. The brush wire and brush terminal are soldered together in the connecting hole so as to be connected with each other. The brush wire and brush terminal are soldered together in the connecting hole of the brush terminal so as to be connected with each other. A ratio of an inner diameter of the connecting hole to an outer diameter of the brush wire is set to be equal to or higher than 1.3 and to be lower than 1.5.

With this configuration of the brush apparatus, because the ratio of the inner diameter D1 of the connecting hole to the outer diameter D2 of the brush wire satisfies 1.3≦D1/D2<1.5, an open space between the brush wire and the connecting hole is adequately reduced as compared with the prior art wherein the inner diameter of a hole is set to be 1.5 or more times larger than an outer diameter of a wire inserted into the hole. Therefore, a volume of solder penetrating into the brush wire can be reduced, and the flexibility or elasticity of the brush wire can be maintained at a proper level. That is, even though a portion of the brush body contacting with the rotor is worn away, a pressing force of the brush body on the slip ring is maintained at a proper level. Accordingly, contact of the brush body with the slip ring can be reliably maintained, and failure in power generation or rotational force generation at an early time can be prevented.

### BRIEF DESCRIPTION OF THE DRAWINGS

FIG. 1 is a longitudinal sectional view of an alternator for a vehicle representing a rotary electric machine according to an embodiment of the present invention;

FIG. 2A is a longitudinal sectional view of a brush apparatus of the alternator shown in FIG. 1;

FIG. 2B is an enlarged longitudinal sectional view of a brush terminal shown in FIG. 2A;

FIG. 3A is another longitudinal sectional view of the brush apparatus;

FIG. 3B is an enlarged longitudinal sectional view of a brush terminal shown in FIG. 3A;

FIG. 4 is a transverse sectional view of the brush apparatus seen from an upper side of the alternator;

FIG. 5 is a view showing a relation between a pressing force of a brush body of the brush apparatus and an amount of penetrating solder;

FIG. 6 is a view showing a relation between a ratio in diameter and an amount of penetrating solder;

FIG. 7 is a view showing a relation between a ratio in diameter and a fraction defective in insertion of a pigtail; and

FIG. 8 is an enlarged longitudinal sectional view of the brush apparatus 5 according to a modification of this embodiment.

### DETAILED DESCRIPTION OF THE PREFERRED EMBODIMENTS

An embodiment of the present invention will now be described with reference to the accompanying drawings.

### EMBODIMENT

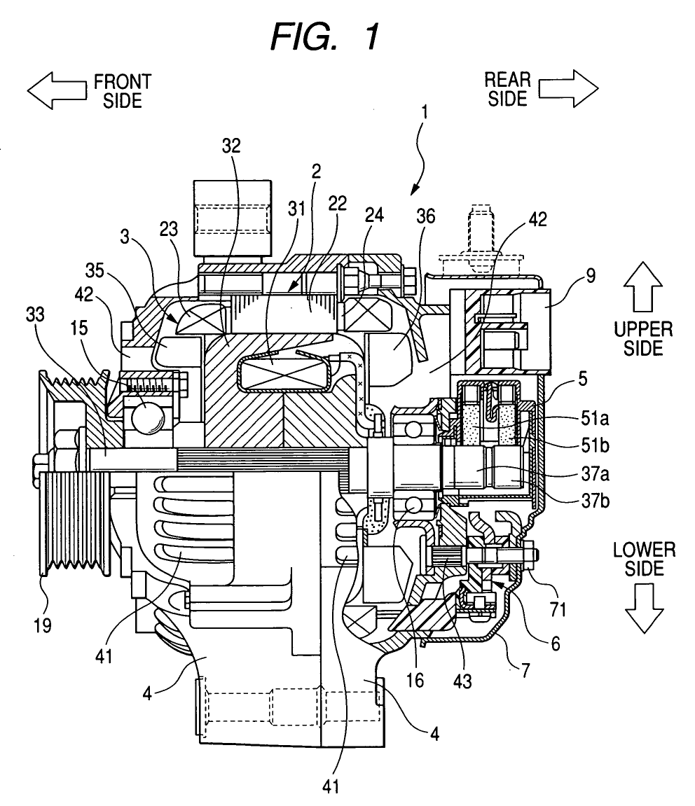

FIG. 1 is a longitudinal sectional view of an alternator for a vehicle representing a rotary electric machine according to an embodiment of the present invention. As shown in FIG. 1, an alternator 1 for a vehicle has a rotor 3, a stator 2 being disposed so as to surround the rotor 3 at a predetermined clearance and generating electric power based on an electro-magnetic effect caused between the rotor 3 and stator 2, a frame 4 surrounding the rotor 3 and stator 2, a rectifier 6 rectifying a three-phase alternating voltage generated in the stator 2 to produce electric power of a direct current, a brush apparatus 5 supplying a portion of the direct current produced in the rectifier 6 to the rotor 3 as an exciting current, an integrated circuit (IC) regulator 9 adjusting a direct current voltage produced in the rectifier 6 by controlling the exciting current supplied to rotor 3, and a rear cover 7 with which electric parts such as the rectifier 6, the brush apparatus 5 and the IC regulator 9 placed on an outer surface of the frame 4 and an end portion of the rotor 3 protruded from the frame 4 toward a rear side of the alternator 1 are covered.

The rotor 3 has a rotary shaft 33 rotatably supported by bearings 15 and 16 on both end portions thereof and receiving a rotational force through a pulley 19, a pole core 32 coupled to the shaft 33 and having six nails disposed along a circumferential direction of the shaft 33, and a field wiring 31 wound on the core 32. The wiring 31 is surrounded by a body and nails of the core 32. The wiring 31 is formed of a copper wire which is covered with an electric insulator of resin and is cylindrically and coaxially wound on the core 32. Two slip rings 37a and 37b (generically indicated by a reference numeral 37) are disposed on a nearly end portion of the shaft 33 on the rear side. The rings 37 are electrically connected with both ends of the field winding 31, respectively.

The brush apparatus 5 has two conductive brush bodies 51a and 51b (generically 51), respectively, contacting with the slip rings 37. When the shaft 33 is rotated in response to a rotational force transmitted from a vehicle engine (not shown) through the pulley 19, the winding 31 and core 32 are rotated with the shaft 33. The brush bodies 51 slide on the slip rings 37 during the rotation of the rotor 3, and an exciting current is supplied from the brush apparatus 5 to the field winding 31 through the brush bodies 51 and the rings 37. In response to the exciting current received from the brush apparatus 5, the winding 31 and core 32 induce magnetic fields such that two nails in each pair are, respectively, set at N and S poles, and the fields are periodically changed during the rotation of the wirings 31 and core 32.

The stator 2 has a stator core 22, three stator windings 23 of three phases wound on the core 22, and an insulator 24 electrically insulating the core 22 and windings 23 from each other. A three-phase alternating current is generated in the windings 23 in response to the changed magnetic fields of the rotor 3.

A cooling fan 35 is attached to an end surface of the core 32 on a front side of the alternator 1 so as to be rotated with the core 32. A cooling fan 36 is attached to an end surface of the core 32 on the rear side so as to be rotated with the core 32. The frame 4 has air intake windows 42 disposed near the fan 35 and air discharging windows 41. The windows 41 are disposed near both end portions of the windings 23 protruded from the core 22 on the front and rear side. The frame 4 further has a large opening 42 on the rear side. The rear cover 7 is fixed to the frame 4 by both a bolt 43 extending from the frame 4 on the rear side and a metallic nut 71 while placing the rectifier 6 between the frame 4 and rear cover 7. When the rotor 3 is rotated, the fan 35 rotated with the core 32 takes air in the alternator 1 through the windows 42 so as to cool the rotor 3 and stator 2 with the air and discharges the air from the windows 41, and the fan 36 rotated with the core 32 takes air in the alternator 1 through the openings of the rear cover 7 and the opening 42 and discharges the air along a radial direction of the shaft 33 to cool the rectifier 6, the brush apparatus 5, the IC regulator 9 and the rotor 3.

Next, the configuration of the brush apparatus 5 is described in detail.

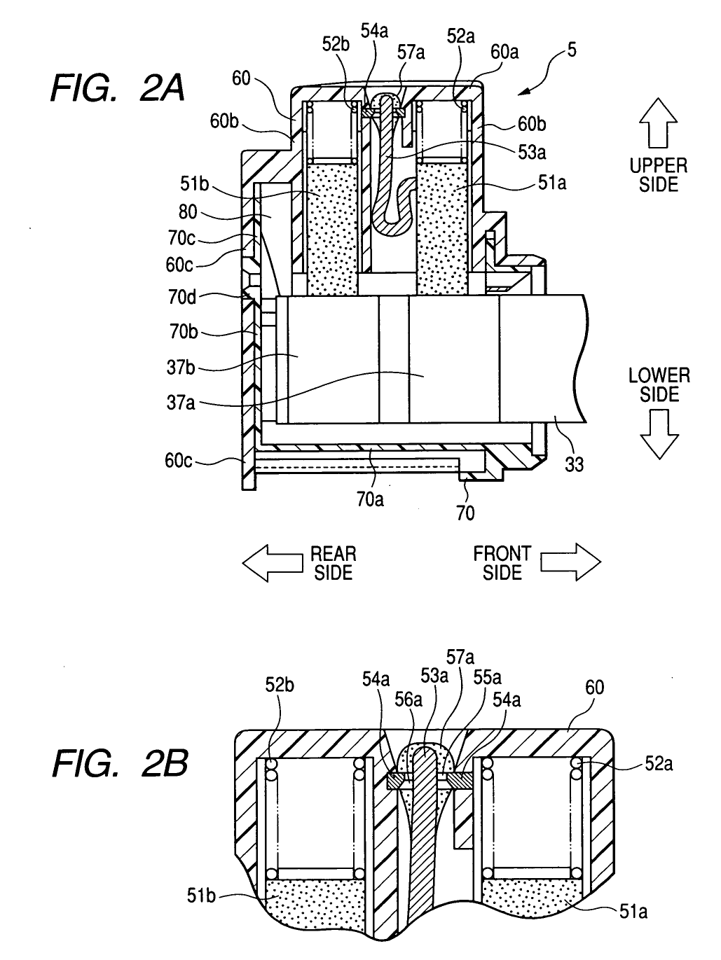

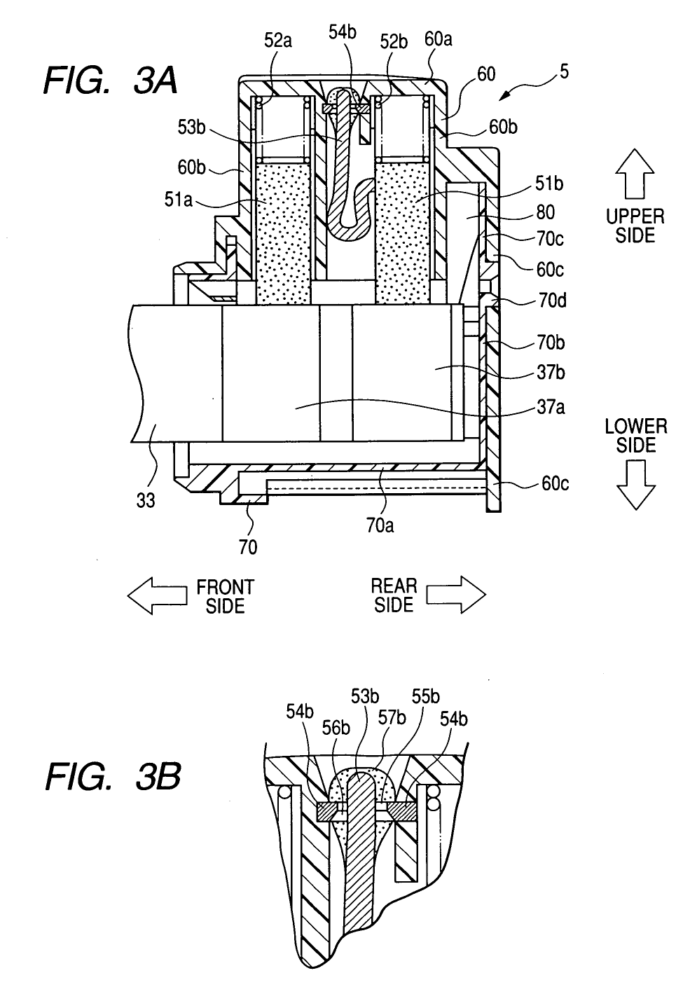

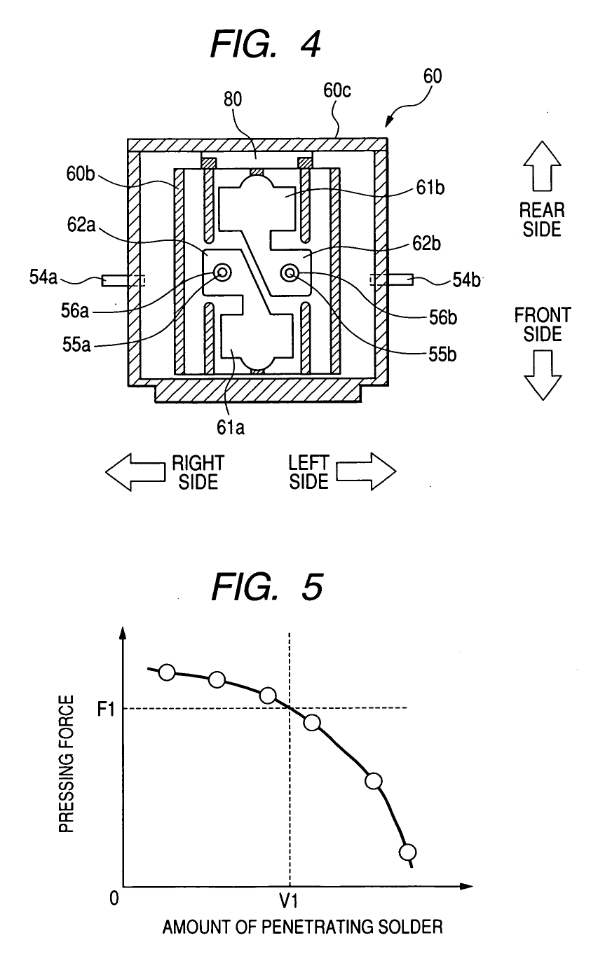

FIG. 2A is a longitudinal sectional view of the brush apparatus 5 mounted on the shaft 33, while FIG. 2B is an enlarged longitudinal sectional view of a brush terminal shown in FIG. 2A. FIG. 3A is another longitudinal sectional view of the brush apparatus 5 mounted on the shaft 33, while FIG. 3B is an enlarged longitudinal sectional view of a brush terminal shown in FIG. 3A. FIG. 4 is a transverse sectional view of the brush apparatus 5 seen from an upper side of the alternator.

As shown in FIG. 2A, FIG. 2B, FIG. 3A, FIG. 3B and FIG. 4, the brush apparatus 5 has the brush bodies 51 (51a and 51b), two springs 52a and 5.2b (generically 52) representing pressing members, respectively, pressing the brush bodies 51 on the slip rings 37, two pigtails 53a and 53b (generically 53), respectively, connected with the brush bodies 51a and 53b, and two brush terminals 54a and 54b (generically 54), respectively, connected with the pigtails 53a and 53b through solder blocks 57a and 57b (generically 57) by soldering. The terminals 54 are electrically connected with the rectifier 6 and the IC regulator 9. Each pigtail 53 denotes a brush wire made of conductive material such as copper and is formed by knitting a plurality of thin copper wires into a thick wire. For example, the pigtail 53 is formed by twisting two, three or four intermediate strings together, and each intermediate string is formed by twisting twenty to thirty thin copper wires together. Each thin copper wire has a diameter ranging from 0.05 to 0.1 mm. Therefore, the pigtail 53 has the proper level of flexibility or elasticity and is easy to bend arbitrarily. An end portion of each pigtail 53 is connected with the corresponding brush body 51 due to a caulked joint using copper powder.

The terminals 54a and 54b have circular connecting holes 55a and 55b (generically 55) , respectively. The holes 55 are, for example, set at the same inner diameter D1 as each other. The pigtails 53 have the same outer diameter D2 as each other. However, the holes 55 may have different inner diameters D1, and the pigtails 53 may have different outer diameters D2. A ratio of the inner diameter(s) D1 of the connecting holes 55 to the outer diameter(s) D2 of the pigtails 53 is set to be equal to or higher than 1.3 and to be lower than 1.5 (1.3≦D1/D2<1.5).

Each brush body 51 is pressed on the slip ring 37 by the spring 52. Therefore, if the flexibility of the pigtails 53 is maintained, the pigtails 53 can be flexibly shifted with the brush body 51 in response to wear or abrasion of the brush body 51, and the brush body 51 can reliably keep electrical connection with the slip ring 37 at an adequate level of pressing force during the rotation of the shaft 33. The rectifier 6, the IC regulator 9 and the field winding 31 of the rotor 3 are electrically connected with one another through the terminals 54, the pigtails 53 and the brush bodies 51 of the brush apparatus 5.

The brush apparatus 5 may further have a brush holder 60 made of resin and a slipping cover 70 made of resin such that an end portion of the shaft 33 on the rear side is covered with the holder 60 and cover 70. The holder 60 is formed in an almost box shape and has a bottom wall 60a, four side walls 60b, and a cap 60c extending from one side wall. The holder 60 is opened on the side opposite to the wall 60a to allow the bodies 51 to contact with the slip rings 37. An end portion of the shaft 33 on the rear side is covered with the cap 60c. A groove 80 extending along a radial direction of the shaft 33 is formed between the cap 60c and the side wall. The terminals 54 are embedded in a center portion of the wall 60a of the holder 60 to be fixed to the holder 60.

The holder 60 further has two brush holders 61a and 61b (generically 61) , respectively, disposed on the front and rear sides and two pigtail holders 62a and 62b (generically 62), respectively, disposed on right and left sides of the alternator 1. The holder 61a holds both the brush body 51a and the spring 52a, and the holder 61b holds both the brush body 51b and the spring 52b. The holder 62a holds the pigtail 53a, and the holder 62b holds the pigtail 53b. The holder 61a communicates with the holder 62a such that the pigtail 53a is connected with the brush body 51a. The holder 61b communicates with the holder 62b such that the pigtail 53b is connected with the brush body 51b.

The cover 70 has a bottom wall 70a, a cap 70b facing the end surface of the shaft 33 on the rear side, a projection portion 70c inserted into the groove 80, and a convex portion 70d between the cap 70b and the projection portion 70c. The cap 60c of the holder 60 has an opening, and the convex portion 70d of the cover 70 is tightly fitted into the opening of the cap 60c. That is, a fitting portion is formed of the opening and the convex portion 70d. Therefore, the connection of the holder 60 and the cover 70 is facilitated, and the holder 60 and the cover 70 can be air-tightly connected with each other.

Each of the holders 62 is formed in a tubular shape. The hole 55a of the terminal 54a is disposed on an bottom side of the pigtail holder 62a opposite to an opening side of the pigtail holder 62a. The hole 55b of the terminal 54b is disposed on an bottom side of the pigtail holder 62b opposite to an opening side of the pigtail holder 62b. Before the brush apparatus 5 is attached to the shaft 33, each pigtail 53 connected with the brush body 51 is once bent toward the opening side or lower side, then turned toward the bottom side or upper side. Thereafter, the pigtail 53 is inserted into the corresponding hole 55 along a pigtail insertion direction directed from the opening side to the bottom side, and the pigtail 53 and terminal 54 are soldered together. Because the pigtail 53 is folded back in the holder 62, an end portion of the pigtail 53 connected with the brush body 51 can be shifted with the brush body 51 toward the lower side when a portion of the brush body 51 contacting with the slip ring 37 is worn away. Therefore, the brush body 51 can keep contacting with the slip ring 37.

In this brush apparatus 5, a ratio of the inner diameter D1 of the connecting holes 55 to the outer diameter D2 of the pigtails 53 is set to be equal to or higher than 1.3 and to be lower than 1.5. Therefore, an open space between each pigtail 53 and the corresponding hole 55 is reduced as compared with the prior art wherein the inner diameter of a hole is set to be 1.5 or more times larger than an outer diameter of a wire inserted into the hole. When the open space is filled with melt solder to connect each pigtail 53 and the corresponding terminal 54, a volume of the melt solder is reduced as compared with that in the prior art. In this case, a volume of solder penetrating into the pigtail 53 is reduced, and there is little probability that solder penetrating into the pigtail 53 or flowing on a outer surface of the pigtail 53 reaches a bending portion of the pigtail 53 and lessens the flexibility of the pigtail 53. Therefore, the flexibility of the pigtail 53 can be maintained at a proper level. That is, even though a portion of the brush body 51 contacting with the slip ring 37 is worn away, the pigtail 53 is flexibly shifted when the spring 52 presses the brush body 51 on the slip ring 37, and a pressing force of the brush body 51 on the slip ring 37 is maintained at a proper level. Accordingly, contact of the brush body 51 with the slip ring 37 of the rotor 3 can be reliably maintained, and failure in power generation in the alternator 1 at an early time can be prevented.

In this embodiment, to facilitate the insertion of the pigtail 53 into the hole 55, the hole 55a of the terminal 54a may have a chamfer 56a on a side facing a connection point of the pigtail 53a and the bush body 51a, and the hole 55b of the terminal 54b may have a chamfer 56b in the same manner. In this case, a tip of the pigtail 53 is moved along the chamfer 56 so as to be naturally led into the hole 55. Accordingly, even though the inner diameter D1 of the holes 55 of the terminals 54 is reduced on condition that the ratio of the inner diameter D1 to the outer diameter D2 satisfies 1.3≦D1/D2<1.5, the pigtail 53 can be easily inserted into the hole 55. That is, workability in the assembling of the brush apparatus 5 can be heightened.

The inventor of the present invention measured a relation among a pressing force of the brush body 51, an amount of penetrating solder, a ratio D1/D2 in diameter and fraction defective in insertion of the pigtail 53. This relation is shown in FIG. 5 to FIG. 7.

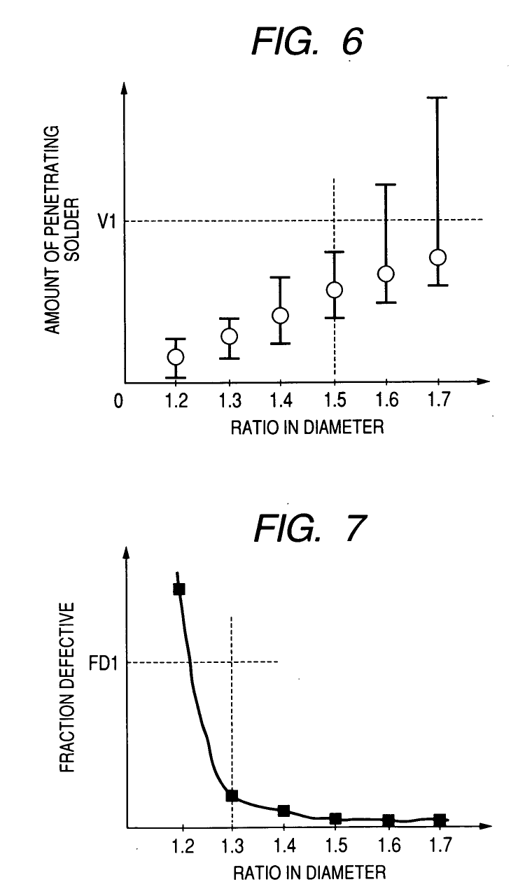

FIG. 5 is a view showing a relation between a pressing force of the brush body 51 and an amount of penetrating solder, FIG. 6 is a view showing a relation between a ratio D1/D2 in diameter and an amount of penetrating solder, and FIG. 7 is a view showing a relation between a ratio D1/D2 in diameter and a fraction defective in insertion of the pigtail 53.

As shown in FIG. 5, as an amount of solder penetrating into the pigtail 53 is increased, a pressing force of the brush body 51 on the slip ring 37 is lowered. When the amount of penetrating solder is lower than a specific value V1, the pressing force becomes higher than a minimum pressing force F1 requiring to cause the brush body 51 to stably contact with the slip ring 37.

As shown in FIG. 6, as the ratio of the inner diameter D1 to the outer diameter D2 is heightened, an amount of solder penetrating into the pigtail 53 is increased. When the ratio D1/D2 is lower than 1.5, the amount of penetrating solder becomes lower than the specific value V1. Therefore, to maintain the pressing force higher than the minimum pressing force F1, the ratio D1/D2 is required to be lower than 1.5.

As shown in FIG. 7, as the ratio of the inner diameter D1 to the outer diameter D2 is lowered, a fraction defective in insertion of the pigtail 53 into the hole 55 is increased. More specifically, as the inner diameter of the hole 55 becomes small, the pigtail 53 interferes with the hole 55 at higher probability during the insertion of the pigtail 53. Therefore, the thin copper wires unified to the pigtail 53 are scattered at higher probability. When the scattered wires and the terminal 54 are soldered together, failure in electrical connection between the pigtail 53 and the terminal 54 is heightened. Further, spaces among the scattered wires cannot be sufficiently filled with solder, and there is high probability that open spaces not filled with solder are generated in the pigtail 53. In this case, when water is entered into the alternator 1, the water is led into the brush holder 60 of the brush apparatus 5 through the open spaces. Therefore, wear or abrasion of the brush bodies 51 are accelerated, and power generation in the alternator 1 is undesirably stopped. To set a fraction defective in the manufacturing of the brush apparatus 5 at a value equal to or lower than an allowable fraction defective FD1, the ratio D1/D2 is required to be equal to or higher than 1.3.

In conclusion, the inventor has found that it is required to set the ratio of the inner diameter D1 to the outer diameter D2 at a value equal to or higher than 1.3 and lower than 1.5.

This embodiment should not be construed as limiting the present invention to structures of this embodiment, and the structure of this invention may be combined with that based on the prior art. For example, in this embodiment, each of the pigtail holders 62 is formed in the tubular shape wherein a transverse sectional area of the bottom side is almost the same as that of the opening side. However, each pigtail holder 62 is not limited to the tubular shape.

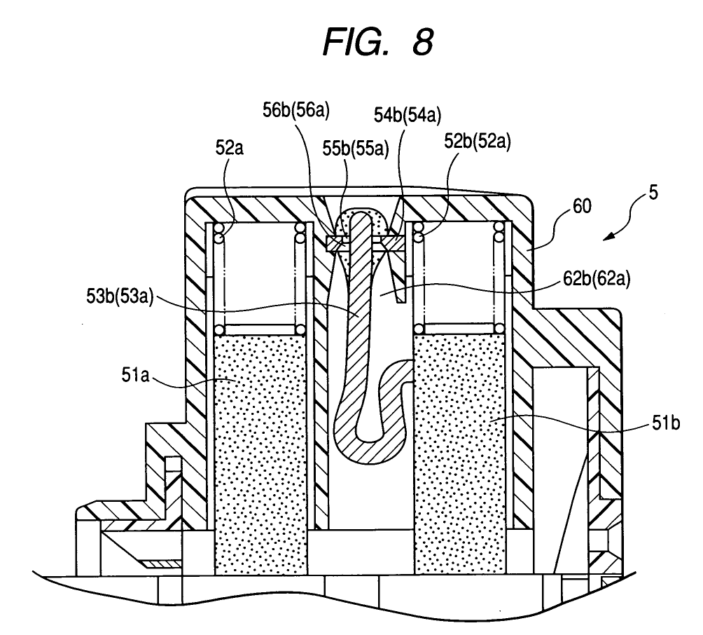

FIG. 8 is an enlarged longitudinal sectional view of the brush apparatus 5 according to a modification of this embodiment.

As shown in FIG. 8, each of the pigtail holders 62 is formed in a shape wherein an area or width of a transverse section of the holder 62 is reduced along the pigtail insertion direction directed from the opening side to the bottom side. With this configuration, when a tip of each pigtail 53 is inserted into the pigtail holder 62 from the opening side, the tip of the pigtail 53 can be easily led toward the hole 55 of the terminal 54. Accordingly, workability in the assembling of the brush apparatus 5 can be further heightened.

Further, a transverse sectional area of the pigtail holder 62 at the bottom side may be set to be almost equal to either the inner diameter of the hole 55 or the outermost diameter of the chamfer 56. In FIG. 8, a transverse sectional area of the pigtail holder 62 at the bottom side is almost equal to the outermost diameter of the chamfer 56. With this structure, a tip of each pigtail 53 can further smoothly and reliably be inserted into the hole 55 of the terminal 54.

In this embodiment and modification, connection between the pigtail 53 and the terminal 54 is described in case of the alternator 1. However, this connection may be applied to a motor wherein a rotational force is generated from electric power. In other words, the connection may be applied to an electric rotational machine wherein generation of electric power from a rotational force or generation of a rotational force from electric power is performed.

What is claimed is:

1. A brush apparatus for a rotary electric machine, comprising:
a brush body contacting with a slip ring of a rotor;
a pressing member which presses the brush body on the slip ring;
a brush wire connected with the brush body; and
a brush terminal having a connecting hole in which the brush wire and the brush terminal are soldered together so as to be connected with each other,
wherein a ratio of an inner diameter of the connecting hole to an outer diameter of the brush wire is set to be equal to or higher than 1.3 and to be lower than 1.5.

2. The brush apparatus according to claim 1, wherein the connecting hole of the brush terminal has a chamfer on a side facing a connection point of the brush wire and the bush body.

3. The brush apparatus according to claim 1, further comprising:
a brush holder to which the brush terminal is fixed and in which the brush body, the pressing member and the brush wire are disposed,
wherein the brush holder has a brush body holder holding the brush body and a brush wire holder holding the brush wire,
and wherein the brush wire holder is formed in a cylindrical shape such that an area of the brush wire holder on a transverse section of the brush wire holder is reduced along a direction from a first side of the brush wire holder facing a connection point of the brush wire and the bush body to a second side of the brush wire holder opposite to the first side.

4. The brush apparatus according to claim 3, wherein the diameter of the brush wire holder on the second side is substantially equal to the inner diameter of the connecting hole.

5. The brush apparatus according to claim 3, wherein a portion of the brush terminal surrounding the connecting hole has a chamfer on a side facing the connection point of the brush wire and the bush body, and the diameter of the brush wire holder on the second side is substantially equal to an outermost diameter of the chamfer.

6. The brush apparatus according to claim 1, wherein the brush wire has flexibility such that the brush wire may be shifted with the brush body.

7. The brush apparatus according to claim 1, wherein the brush wire has a plurality of conductive wires unified as a single wire.
